(19) United States
(12) Patent Application Publication
(10) Pub. No.: US 2006/0137103 A1
(43) Pub. Date: Jun. 29, 2006

(54) Process for the preparation of bio-tanning agent

(75) Inventors: Thanaikaivelan Palanisamy, Tamil Nadu (IN); Saravanabhavan Subramani, Tamil Nadu (IN); Jonalagadda Raghava Rao, Tamil Nadu (IN); Chandrasekaran Bangaru, Tamil Nadu (IN); Balachandran Unni Nair, Tamil Nadu (IN); Ramasami Thirumalachari, Tamil Nadu (IN)

Correspondence Address: NIXON & VANDERHYE, PC, 901 NORTH GLEBE ROAD, 11TH FLOOR, ARLINGTON, VA, 22203, US

(73) Assignee: COUNCIL OF SCIENTIFIC AND INDUSTRIAL RESEARCH, New Delhi (IN)

(21) Appl. No.: 11/024,041

(22) Filed: Dec. 29, 2004

(51) Int. Cl. C14C 1/00

(52) U.S. Cl. 8/94.15

(57) ABSTRACT

The present invention provides a process for preparing a bio-tanning agent from collagenous source.

### FIELD OF THE INVENTION

The present invention relates to a process for the preparation of bio-tanning agent. More particularly, the present invention provides a simple process for preparing bio-tanning agent from collagenous source. It is envisaged to have enormous potential application in leather processing industry as an environment friendly option for tanning bides/skins, whereby the pollution load would be significantly reduced compared to that of the conventional tanning process.

### BACKGROUND OF THE INVENTION

Commercially skins/hides are tanned, stabilized against microbes and beat, using chromium salts. Conventional chrome tanning is a popular and mostly practiced technique in the world and employs basic chromium sulfate salt, a progenitor of several chromium species. The kinetic inertness of certain chromium species lends itself to poor exhaustion of chrome tanning. Thus the commercial chrome tanning activities release chromium in the range of 2000-5000 ppm. As reported by Baral and Engelken (Environmental Science & Policy, 5, 121, 2002), the discharge of industrial wastewater containing chromium into water bodies has a significantly polluting impact on the environment. It has been proved that chromium has the ability to cause cancer, as reported by Tsou et al (Chemical Research in Toxicology, 10, 962, 1997) and cell death, as reported by Blankenship et al (Toxicology and Applied Pharmacology, 126, 75, 1994). The wide ecological concern as well as economic loss has prompted the researchers to look for suitable alternatives for chromium. Several methods have been evolved over the years for better management of chromium in leather industry as reported by Chandrasekaran (Leather Science, 34, 91, 1987). Among them the development of alternative tanning agent to chromium has been gaining momentum.

Covington (Chemical Society Reviews, 26, 111, 1997) has reported the use of metal ions like aluminium, titanium, zirconium and iron for tanning. However, the major disadvantages with these products are that the tanning is not complete and some of the metals are toxic to humans. In addition, these products lack the ability to withstand pH conditions above 5.5, as described by Bienkiewicz (Physical Chemistry of Leather Making, Krieger RE Publishing Company, Florida, Chapter 15, 1983). Though several efforts have been taken to overcome these drawbacks, universal availability, toxicity and high cost have forced the researchers to look for other alternatives as well. Several attempts are therefore being made to replace the toxic chemical based auxiliary with non-toxic bio based product for tanning skins/bides. This is because the potential bio resource is available abundantly.

Leather processing leads to the generation of large amounts of solid and liquid wastes. Protein based solid wastes acquire much attention due to its high value. Skin/hide losses its mass up to 70% during leather making processes. The tanned wastes primarily consist of chromium and protein. Historically, the tanned wastes were disposed of in landfills. However, due to stringent restriction on the disposal of chromium bearing wastes as well as the presence of valuable protein source, the tanning industry seeks alternatives to dumping as reported by Lipsett (Journal of the American Leather Chemists Association, 77, 291, 1982). Reference may be made to Brown et al (Journal of the American Leather Chemists Association, 89, 215, 1994), who subjected the leather wastes to chemical as well as enzymatic treatment for separating the protein-bound chromium and using the protein and chromium fractions for several applications. Direct application of tanned wastes is many fold such as the manufacture of bonded leather, leather boards, fibrous sheets grafted with acrylates, insulators and building materials, composites for footwear, sound-proof roofing material, etc as discussed by Rao et al (Journal of the American Leather Chemists Association, 99, 170, 2004). The non-tanned wastes such as raw hide/skin trimmings, limed hide splits, hair, hide/skin fleshings, delimed wastes/trimmings have been processed in to various useful products such as glue, gelatine, pet treats and collagen for medical use as described by Mann (Processing and utilization of animal byproducts, FAO, 1962).

Commercial preparation of protein hydrolysates, for reducing the molecular size of the protein, is accomplished by one of three methods namely acid, alkaline or enzymatic hydrolysis by breaking peptide bonds. Acid and alkali hydrolysis of protein leads to decreased nutritive value because of recemisation and destruction of essential amino acids, production of toxic constituents like lysino-alanine as stated by Swamylingappa et al (U.S. Pat. No. 6,589,574, 2003). Enzymatic methods accomplish protein hydrolysis selectively without causing structural changes in the amino acids that make up the proteins. There are several reports and patents available for enzymatic hydrolysis of proteins due to its high selectivity thereby yielding high end products used in food or pharmaceutical industries, as reported by Milan et al (U.S. Pat. No. 5,948,766, 1999) and Blortz et al (U.S. Pat. No. 5,985,337, 1999).

Acid hydrolysis of proteins is usually not recommended for high end products due to several reasons. Tryptophan is usually totally lost in an acid hydrolysis as shown by Levine (Journal of Chromatography A, 236, 499, 1982). Cystine, serine and threonine are partially broken down and asparagine and glutamine are converted to their acidic forms. Vitamins are mostly destroyed by acid hydrolysis. However, low end industries such as leather processing do not need high end products. Enzymatic hydrolysis not only has the disadvantage of being relatively expensive, but also requires strictly controlled process conditions to achieve maximum results.

An alkaline or acid pressure protein-hydrolysis process was developed by Vaille (Great Britain Patent 1,227,534, 1971) and followed by many of the researchers and commercial protein hydrolysate manufacturers for the past three decades. The process consists of subjecting natural collagen to the action of a pH modifying agent which is acid or alkaline and which establishes, alone or in conjunction with a buffer medium, a pH of 3 to 3.5 or of 8 to 8.5 respectively at a temperature as high as 111° C. at normal pressure and as high as 150° C. under elevated pressure, for a period of 45 to 90 minutes, followed by neutralization. The obtained compounds are particularly used in the therapeutic field. The drawback of this method is the use of very high temperature and stringent control of parameters such as pH and pressure.

No prior art is available on hydrolysing collagen at a temperature not exceeding 98° C. for using as a tanning agent.

### OBJECTS OF THE INVENTION

The main objective of the present invention is to provide a process for the preparation of bio-tanning agent, which precludes the drawbacks stated above.

Another objective of the present invention is to provide a process for preparing bio-tanning agent that does not require very high temperature.

Yet another objective of the present invention is to provide a process for preparing bio-tanning agent that does not require strict control measures such as pH and pressure.

Still another objective of the present invention is to provide a process for preparing bio-tanning agent that does not require any buffering medium.

### SUMMARY OF THE INVENTION

Accordingly, the present invention provides a process for the preparation of bio-tanning agent, which comprises
(a) treating collagenous material in aqueous medium, to a temperature in the range of 80-98° C. at a pH not exceeding 3.0 for a period not less than 30 minutes by known method using known acid, to obtain a slurry followed by adjusting the temperature of the slurry in the range of 20-40° C.,
(b) adjusting the pH of the slurry, as formed in step (i), in the range of 5.5-7.0 by known method to obtain the bio-tanning agent in liquid form,
(c) drying the bio-tanning agent liquid at 130-260° C., as formed in step (ii), by known method as an optional step, to obtain the bio-tanning agent in the dry powder form.

In an embodiment of the present invention, the collagenous material used may be selected from raw hide/skin trimmings, limed hide splits, green fleshings, limed skin/hide fleshings, delimed pelt wastes/trimmings, hide powder either alone or in any combination.

In another embodiment of the present invention, the amount of water used may be in the range of 50-200% by volume on the wet weight of the collagenous material.

In yet another embodiment of the present invention, the acid used may be selected from sulfuric acid, formic acid, acetic acid, hydrochloric acid either alone or in any combination.

In still another embodiment of the present invention, the known method of drying may be such as spray drying, drum drying.

### DESCRIPTION OF THE INVENTION

The invention provides a process for the preparation of a bio-tanning agent by:
i. treating collagenous material in aqueous medium, to a temperature in the range of 80-98° C. at a pH not exceeding 3.0 for a period not less than 30 minutes by known method using known acid, to obtain a slurry followed by adjusting the temperature of the slurry in the range of 20-40° C.,
ii. adjusting the pH of the slurry, as formed in step (i), in the range of 5.5-7.0 by known method to obtain the bio-tanning agent in liquid form,
iii. drying the bio-tanning agent liquid at 130-260° C., as formed in step (ii), by known method as an optional step, to obtain the bio-tanning agent in the dry powder form.

The collagenous material used is selected from raw hide/skin trimmings, limed hide splits, green fleshings, limed skin/hide fleshings, delimed pelt wastes/trimmings, hide powder either alone or in any combination. The amount of water used may be in the range of 50-200% by volume on the wet weight of the collagenous material. The acid used is selected from sulfuric acid, formic acid, acetic acid, hydrochloric acid either alone or in any combination. Drying is achieved by known methods such as spray drying or drum drying.

The process of the present invention is described below in detail.

Collagenous material is added to 50-200% by volume of water, measured on the wet weight of the collagenous source and treated with known acid to adjust the pH at not more than 3 at a temperature in the range of 80-98° C. for a period not less than 30 minutes. The temperature of the mixture is then adjusted in the range of 20-40° C. pH of the resulting slurry is adjusted in the range of 5.5-70 by adding known alkali to obtain the bio-tanning agent in liquid form. This is optionally dried by known method at a temperature in the range of 130-260° C. to obtain the bio-tanning agent in dry powder form. The inventive step of the present invention lies in treating collagen material with a known acid, adjusting the pH at less than 3.0 to facilitate preparation of bio-tanning agent in solution form at a relatively low temperature in the range of 80-98° C. and without controlling pressure.

The invention is described in detail in the following illustrative examples, and should not be construed to limit the scope of the present invention.

### EXAMPLE 1

Raw hide/skin trimmings, weighing 4 kg, were washed in 12 lit water for 2 hrs in a pit. Then the trimmings were again washed in 12 lit fresh water for 2 hrs. The washed trimmings were sliced into small pieces using mechanical slicer. The sliced material weight was found to be 4.8 kg and charged into a reactor. 7.2 lit water and 60 gms concentrated sulfuric acid was added to the reactor with stirring. Then the reactor was heated to 98° C. with continuous stirring for a period of 120 minutes. The pH of the solution was found to be 1.5. Obtained viscous solution was air cooled to 40° C. The cooled solution was neutralized to a pH 7.0 using 48 gms sodium hydroxide with continuous stirring. Then the mixture was drum dried at 130° C. and the resulting bio-tanning agent powder was stored in a plastic container. Total weight of the dried powder was found to be 1300 gms.

### EXAMPLE 2

Limed hide splits, weighing 6 kg, were sliced into small pieces using mechanical slicer. The weight of the sliced material was found to be 5.6 kg. The sliced materials were washed with 11.2 lit water for 15 minutes in a reactor. Then, the water was drained from the reactor. 2.8 lit water and a mixture of 84 gms concentrated sulfuric acid, 56 gms formic acid and 28 gms hydrochloric acid were added to the reactor with stirring. Then the reactor was heated to 95° C. with continuous stirring for a period of 30 minutes. The pH of the solution was found to be 1.3. Obtained viscous solution was cooled to 37° C. using water cooling system. The cooled solution was neutralized to a pH 5.5 using 140 gms sodium hydroxide and 28 gms sodium carbonate with continuous stirring. Then the solution was spray dried at a temperature of 260° C. and the resulting bio-tanning agent powder was stored in a plastic container. Total weight of the dried powder was found to be 1550 gms.

### EXAMPLE 3

The raw hide/skin trimmings and green hide fleshings, weighing 4 kgs and 2 kgs, were washed in 12 lit water for 2 hrs in a pit. Then the trimmings and green fleshings were again washed in 12 lit water for 2 hrs. The washed trimmings and green fleshings were sliced into small pieces using mechanical slicer. The sliced material weight was found to be 7.4 kg and charged into a reactor. 14.8 lit water and a mixture of 92.5 gms concentrated sulfuric acid, 18.5 gms acetic acid and 37 gms formic acid were added to the reactor with stirring. Then the reactor was heated to 98° C. with continuous stirring for a period of 60 minutes. The pH of the solution was found to be 1.2. Obtained viscous solution was air cooled to 36° C. The cooled solution was neutralized to a pH 6.5 using 74 gms sodium hydroxide and 18.5 gms potassium hydroxide with continuous stirring. Then the solution was drum dried at 130° C. and the resulting bio-tanning agent powder was stored in a plastic container. Total weight of the dried powder was found to be 1700 gms.

### EXAMPLE 4

Delimed pelt wastes/trimmings, weighing 8 kgs, were sliced into small pieces using mechanical slicer. The weight of the sliced material was found to be 7.5 kg. The sliced material was washed with 22.5 lit water for 15 mins in a reactor. Then, the water was drained from the vessel. 7.5 lit water and 75 gms concentrated sulfuric acid was added to the reactor with stirring. Then the reactor was heated to 97° C. with continuous stirring for a period of 50 minutes. The pH of the solution was found to be 1.5. Obtained viscous solution was air cooled to 38° C. The cooled solution was neutralized to a pH 7.0 using 56.2 gms sodium hydroxide and 18.7 gms sodium carbonate with continuous stirring. Then the solution was drum dried at 130° C. and the resulting bio-tanning agent powder was stored in a plastic container. Total weight of the dried powder was found to be 2150 gms.

### EXAMPLE 5

Delimed pelt wastes/trimmings and limed fleshings, weighing 5 kgs and 2 kgs, were sliced into small pieces using mechanical slicer. The sliced weight of the material was found to be 6.6 kg. The sliced materials were washed with 19.8 lit water for 15 mins in a reactor. Then, the water was drained from the reactor. 6.6 lit water and 99 gms concentrated sulfuric acid was added to the reactor with stirring. Then the reactor was heated to 92° C. with continuous stirring for a period of 90 minutes. The pH of the solution was found to be 1.6. Obtained viscous solution was cooled to 20° C. using ice water cooling system. The cooled solution was neutralized to a pH 6.5 using 66 gms sodium hydroxide with continuous stirring. Then the solution was drum dried at 130° C. and the resulting bio-tanning agent powder was stored in a plastic container. Total weight of the dried powder was found to be 2050 gms.

### EXAMPLE 6

Hide powder, weighing 2 kgs, was washed with 4000 ml water in a pit for 3 hrs. The weight of the washed wet hide powder was found to be 7.8 kg. The wet hide powder was charged into a reactor. To this, 7.8 lit water and 78 gms concentrated sulfuric acid was added to the reactor with stirring. Then the reactor was heated to 80° C. with continuous stirring for a period of 30 minutes. The pH of the solution was found to be 1.2. Obtained viscous solution was air cooled to 37° C. The cooled solution was neutralized to a pH 7.0 using 58.4 gms sodium hydroxide and 19.6 gms sodium carbonate with continuous stirring. Then the solution was spray dried at a temperature of 260° C. and the resulting bio-tanning agent powder was stored in a plastic container. Total weight of the dried powder was found to be 1900 gms.

The following are the advantages of the present invention:

1. This process does not require very high temperature for the hydrolysis of collagen wastes/fibers

2. This process hardly requires any complicated control measures such as pH and pressure.

3. The process leads to significant reduction in time and power.

4. Suitable for all kinds of raw materials.

5. The developed product has wide applications in leather industry, especially as a bio-tanning agent, thereby replaces toxic or hard biodegradable conventional tanning agents.

Product Characteristics

| Appearance | Pale brown powder |
|---|---|
| Moisture (%) | 1.5 ± 0.5 |
| pH (10% dilution) | 5.5 ± 0.1 |
| Carbon (%) | 27 ± 0.5 |
| Hydrogen (%) | 4.7 ± 0.1 |
| Nitrogen (%) | 9.6 ± 0.2 |

Comparative Advantages over the Prior Art

| S. | Process | Present | |
|---|---|---|---|
| No. | parameters | invention | Prior art |
| 1. | Temperature | 80-98° C. | Up to 110° C. |
| | | | at normal pressure |
| | | | Up to 150° C. |
| | | | under elevated |
| | | | pressure |
| 2. | Pressure | Normal | Requires elevated |
| | | (atmospheric) | pressure in some |
| | | | cases |
| 3. | Buffer | No need of | Required in some |
| | requirement | buffering | cases |
| 4. | pH of the | Not more | 3 to 3.5 or |
| | hydrolysis step | than 3.0 | 8 to 8.5 |
| 5. | Raw material | Natural collagen | Natural |
| | | or collagen | collagen |
| | | wastes either | |
| | | alone or in | |
| | | combination | |
| 6. | Use of the | For tanning | For medical or |
| | product | applications | therapeutic |
| | | | applications |

We claim:

1. A process for the preparation of bio-tanning agent, which comprises:
i. treating a collagenous material in aqueous medium with an acid at a temperature in the range of 80-98° C. and at a pH not exceeding 3.0 for a period not less than 30 minutes to obtain a slurry followed by adjusting temperature of the slurry to a range of 20-40° C.,
ii. adjusting pH of the slurry formed in step (i) to a range of 5.5-7.0 to obtain the bio-tanning agent in liquid form.

2. A process as claimed in claim 1 wherein the bio-tanning agent in liquid form obtained in step (ii) is dried at a temperature in the range of 130-260° C. to obtain the bio-tanning agent in dry powder form.

3. A process as claimed in claim 1 wherein the collagenous material used is selected from the group consisting of raw hide/skin trimmings, limed hide splits, green hide fleshings, limed skin/hide fleshings, delimed pelt wastes/trimmings, hide powder either alone or in any combination thereof.

4. A process as claimed in claim 1 wherein the amount of water used is in the range of 50-200% by volume on wet weight of the collagenous material.

5. A process as claimed in claim 1 wherein the acid used is selected from the group consisting of sulfuric acid, formic acid, acetic acid, hydrochloric acid either alone or in any combination thereof.

6. A process as claimed in claim 2 wherein the drying is achieved by spray drying or drum drying.
